(19) United States
(12) Patent Application Publication
(10) Pub. No.: US 2009/0128938 A1
(43) Pub. Date: May 21, 2009

(54) Visors and rearview mirrors for helmets

(76) Inventor: Stephen A. Carnes, Victorville, CA (US)

Correspondence Address: F. Eugene Logan;Law Office of F. Eugene Logan, Suite 201, 202 Fashion Lane, Tustin, CA, 92780, US

(21) Appl. No.: 11/985,698

(22) Filed: Nov. 16, 2007

(51) Int. Cl. G02B 5/24

(52) U.S. Cl. 359/886; 359/872

(57) ABSTRACT

A visor that is especially useful for motorcycle riders and especially for off-road motorcycle racing. The visor has a sun shade member and a mirror. The mirror is affixed to an under surface of the sun shade member. The mirror has a continuous convex surface with a curvature that is free of discontinuations and step changes. The mirror is spaced an effective distance from the user's eyes and has a lateral span and a longitudinal span that are large enough so that the helmet wearer can simultaneously see approximately the same field of view to a side and rear with each eye by a slight turn and tilt of the user's head while an unobstructed line of sight in the direction of travel is retained. The invention also includes a mirror that can be retrofitted to various sun shade members and a kit for retrofitting the mirror in existing sun shade members.

### BACKGROUND OF THE INVENTION

Riders of two wheel vehicles such as bicycles and motorcycles have conceived a variety of devices for appraising activity occurring behind their vehicles. For example, U.S. Pat. No. 3,594,069 disclosed a helmet-mountable face shield with single planar mirror positioned below eye level to reflect the user's line of sight rearward and below the maximum width of the helmet. U.S. Pat. No. Des. 224,821 disclosed a helmet-attachable visor with spaced apart left and right rearward directed planar mirrors. U.S. Pat. No. 3,804,495 disclosed a helmet-mounted visor with a prism that directs the wearer's line of sight upwards and an adjustable planar mirror that then directs the line of sight back over the top of the helmet. The mirror is attached to an upright support mounted on the top of the visor.

More complex devices for other uses have also been conceived. For example, U.S. Pat. No. Re 28,847 disclosed a pilot's helmet with an optical system having a visor or face mask with a partially reflective surface, and a light emitting means that displays certain information on the visor.

U.S. Pat. No. 3,978,526 disclosed a helmet with three planar mirrors that directs the wearer's line of sight up and back over the top of the helmet through a tunnel formed by a support structure for the mirrors and the front top portion of the conventional protective shell of the helmet.

U.S. Pat. No. 4,651,357 disclosed a helmet-mountable face shield with left and right side planar mirrors that extend laterally beyond the normal outward profile of the helmet.

U.S. Pat. No. 4,722,101 disclosed a helmet-mountable visor having an optical system with a plurality of mirrors and lenses for seeing the field of view behind the user. Convex and/or concave mirrors and lenses are used in variety of combinations to direct the helmet wearer's line of sight behind the helmet.

U.S. Pat. No. 4,755,023 disclosed a head mounted display visor using plastic materials and optical coatings. The visor is produced by injection molding in a mold produced by state-of-the-art numerically controlled milling, grinding, and polishing tools.

U.S. Pat. No. 4,761,056 disclosed a helmet-mounted complex optical system with cathode ray tube (“CRT”) for optical display on a parabolic segment of a visor attached to the helmet.

U.S. Pat. Nos. 5,076,701 and Des. 331,902 disclosed a bicycle helmet-mountable adjustable side planar mirror with an extension arm for seeing the field of view behind the helmet. The extension arm extends beyond the outer periphery of the helmet.

U.S. Pat. No. 5,432,960 disclosed a motorcycle helmet with rearview planar left and right side mirrors that extend beyond the outer periphery of the helmet for seeing the field of view behind the helmet.

U.S. Pat. No. Des. 389,605 disclosed a sportsman's helmet-mounted left and right side rearview adjustable planar mirrors on arms that extend beyond the outer periphery of the helmet for seeing the field of view behind the helmet.

U.S. Pat. No. Des. 392,071 disclosed a visor-mounted adjustable rearview planar mirror on an arm that extends beyond the outer periphery of a safety helmet and visor for seeing the field of view behind the helmet.

U.S. Pat. No. Des. 402,421 disclosed a helmet-mountable side rearview planar mirrors on arms that extend beyond the outer periphery of the helmet for seeing unidentified fields of view.

U.S. Pat. No. 5,884,337 disclosed a flip-down rearview planar mirror attached to an under side of a brim of an item of apparel such as a cap or hat.

U.S. Pat. No. 6,007,198 disclosed an adjustable rearview planar mirror mounted to a visor of a cap. The mirror element is entirely plastic, except for a thin film of polished aluminum deposited on a polyester base or a Mylar® brand plastic backing.

U.S. Pat. No. 6,357,882 disclosed a helmet-mounted visor with two rearview planar mirrors for seeing the field of view behind and to each side of the helmet. The right mirror is for seeing the field of view behind and on the right side of the helmet and the left mirror is for seeing the field of view behind and on the left side of the helmet. The mirror system is said to be such that each eye views a different portion of the field of view through each mirror. It is also stated that for some applications, for example cycling, the mirror surfaces are offset from the vertical plane so that the mirrors enable a user to view the desired view behind, as shown in FIG. 4. . . . . In the embodiment shown in FIG. 4, the offset angle φ is about 10 degrees . . . .

U.S. Pat. No. 6,493,882 disclosed a helmet-mounted three mirror optical system that directs the helmet wearer's line of sight up and back over a channel formed above the foam padding in the helmet and body of the helmet. The field of view behind the helmet wearer is reflected by a concave, off axis parabolic mirror to a substantially flat mirror then to a convex, off axis parabolic mirror and then to the user's eyes.

U.S. Pat. No. 6,485,151 disclosed a motorcycle-handlebar mountable mirror system with planar left and right innermost mirrors and adjacent convex left and right outermost mirrors for extending the posterior viewing area behind the motorcycle.

### SUMMARY OF THE INVENTION

The visors with integral mirrors of this invention are particularly useful for off-road motorcycle riding or racing on natural or rough terrains. Such terrains are sometimes strewn with objects such as fallen branches, stone and other debris that may lie in the path of the motorcycle rider. Debris can also be thrown in the path of a motorcycle rider by other off-road vehicles traveling the path earlier. These hazards can be particularly dangerous to the motorcycle rider if not seen especially when racing.

Thus it is risky for an off-road motorcycle rider to turn his body and head around to look directly over the rear of his motorcycle to directly view the activity behind his motorcycle. It therefore is desirous for a motorcycle rider to be able to appraise the activity behind his motorcycle without having to twist his body and head around.

Furthermore, when a motorcycle rider is racing even on a prepared motorcycle track it would be useful to the motorcycle rider to be able to appraise the traffic behind him without turning his body but only by a slight turning and tilting of his head while still retaining his peripheral view of the track in front of his motorcycle by merely eye movement.

Still further, whether racing on track or off-road a participant in the event would have an advantage if he could easily, quickly and safely appraise a competitor that is rapidly gaining ground and with this knowledge take defensive action to remain in the lead.

Since off-road motorcycle riders can encounter all sorts of unexpected debris or traffic in their paths, it is desirable that any mirror-containing attachments to their helmets or visors:
(1) not interfere with their view of the path ahead and their peripheral vision to their sides,
(2) not have arms or members that extend beyond the normal periphery of the helmets and visors that could for example be snagged with branches or bushes,
(3) be securely affixed, directly or indirectly, to the helmets sufficiently to prevent movement relative to the helmets, including vibrational movement, that would blur the field of view to the rear, and
(4) be streamlined or aerodynamically shaped sufficiently to prevent movement relative to the helmets and visors.

It is also desirable that such mirror-containing attachments be completely above the eye level of the helmet wearer so that such attachments can not interfere with the motorcycle rider's line of sight to the front of the motorcycle or his peripheral sight.

The visors with integral mirrors of this invention satisfy all of these conditions and more.

Therefore; although this invention is particularly useful for off-road motorcycle racing, it will be apparent that this invention can also be used for riding on surface streets and highways and for bicycling so that the user can appraise the traffic behind him without losing sight of the traffic ahead.

This invention also includes mirrors for affixing to existing visor not equipped with a mirror, referred to herein after as “sun shade members”, as well as helmets with the visors of this invention.

### BRIEF DESCRIPTION OF THE DRAWINGS

FIG. 1 is a left side view of a motorcycle rider with a visor of this invention attached to his helmet and with his head positioned so that he can view other riders on his left and to the rear.

FIG. 2 is a front view of the motorcycle rider of FIG. 1 with his head positioned so that he can view a second rider on his left and to the rear. The second rider is also wearing a helmet with a visor of this invention with his head positioned so that he can view the first rider.

FIG. 3 is a view looking down on the motorcycle rider of FIG. 1 with his head positioned so that he can view other motorcycle riders on his right and to the rear.

FIG. 4 is a view of the motorcycle rider of FIG. 3 as seen from the rear with his head position so that he can view other riders on his right and to the rear.

FIG. 5 is a left side view of the visor of FIG. 1 secured to the helmet.

FIG. 6 is a top view of the visor secured to the helmet shown in FIG. 5.

FIG. 7 is a cross-sectional view of the visor and helmet of FIG. 5 with the helmet tightly secured to the a helmet wearer's head with a chin strap.

FIG. 8 is a cross-sectional view of the visor and helmet of FIG. 5 with the helmet wearer's head turned slightly to the left and tilted slightly upwards on his left as in FIGS. 1 and 2 so that he can view other riders on his left and to the rear.

FIG. 9 is a top view of the visor of FIG. 5 detached from the helmet.

FIG. 10 is a bottom view of the visor of FIG. 9 showing the mirror.

FIG. 11 is a right side view of the visor of FIG. 9, the left side view being a mirror image FIG. 11.

FIG. 12 is a rear view of the visor of FIG. 9.

FIG. 13 is a bottom and rear perspective of the visor of FIG. 9.

FIG. 14 is a bottom and front perspective of the visor of FIG. 9.

FIG. 15 is a bottom view of a detail of the visor of FIG. 9 showing the mirror.

FIG. 16 is front view of the detail of FIG. 15 as seen in direction of arrows 16 of FIG. 15.

FIG. 17 is a left side view of the detail of FIG. 15 showing the mirror as seen in direction of arrow 17 of FIG. 15; the right side view being the mirror image of FIG. 17.

FIG. 18 is a cross-sectional view of the detail of FIG. 15 taken through line 18-18 of FIG. 15; the cross-sectional view in the opposite direction being the mirror image of FIG. 18.

FIG. 19 is a bottom view of a detail of a second embodiment of a visor showing the mirror.

FIG. 20 is front view of the detail of FIG. 19 as seen in direction of arrows 20 of FIG. 19.

FIG. 21 is a left side view of the detail of FIG. 19 showing the mirror as seen in direction of arrows 21 of FIG. 19; the right side view being the mirror image of FIG. 21.

FIG. 22 is a cross-sectional view of the detail of FIG. 19 taken through line 22-22 of FIG. 19; the cross-sectional view in the opposite direction being the mirror image of FIG. 22.

FIG. 23 is a top view of a continuous single spherical mirror for affixing to a sun shade member.

FIG. 24 is a front view of the mirror of FIG. 23.

FIG. 25 is a detail through lines 25 of FIG. 23.

FIG. 26 is a detail through lines 26 of FIG. 23.

FIG. 27 is a template for drilling holes in a visor.

FIG. 28 is another embodiment of a visor with means for varying the fixed position of the visor relative to the helmet.

### DESCRIPTION OF THE PREFERRED EMBODIMENTS

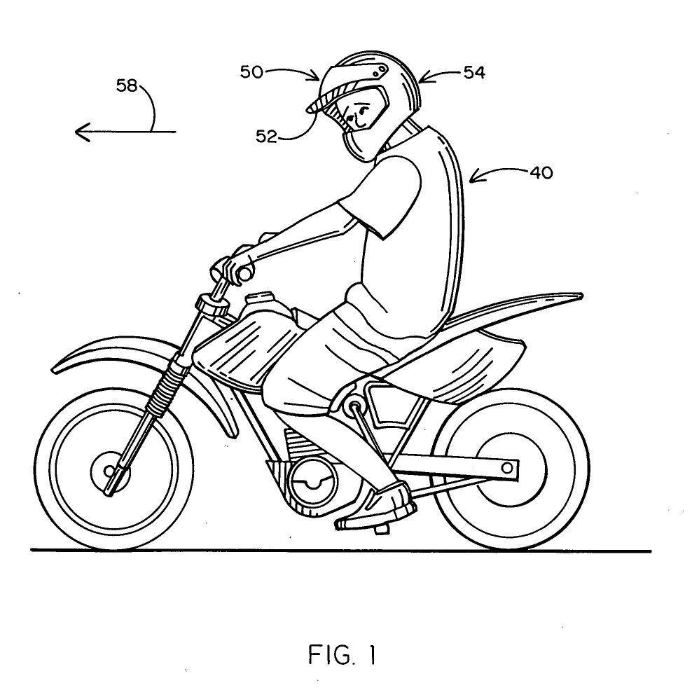

FIGS. 1-4 illustrate how a visor 50 with an integral mirror 52 of this invention is used when affixed to a motorcycle helmet 54.

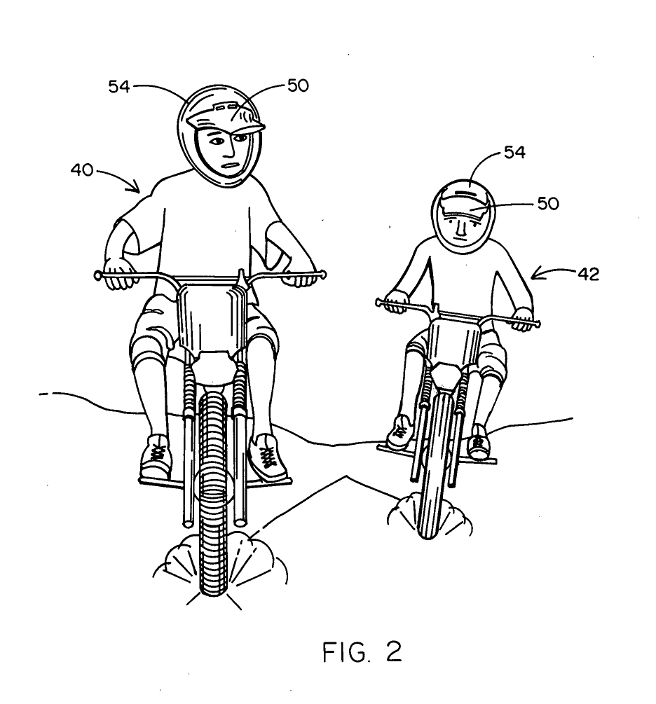

In particular FIGS. 1-2 illustrate how a first motorcycle rider 40 can see a second motorcycle rider 42 to his left and rear by turning his head slightly to the left and tilting his head slightly upwards on his left to see an image of the second motorcycle rider 42 in the mirror 52.

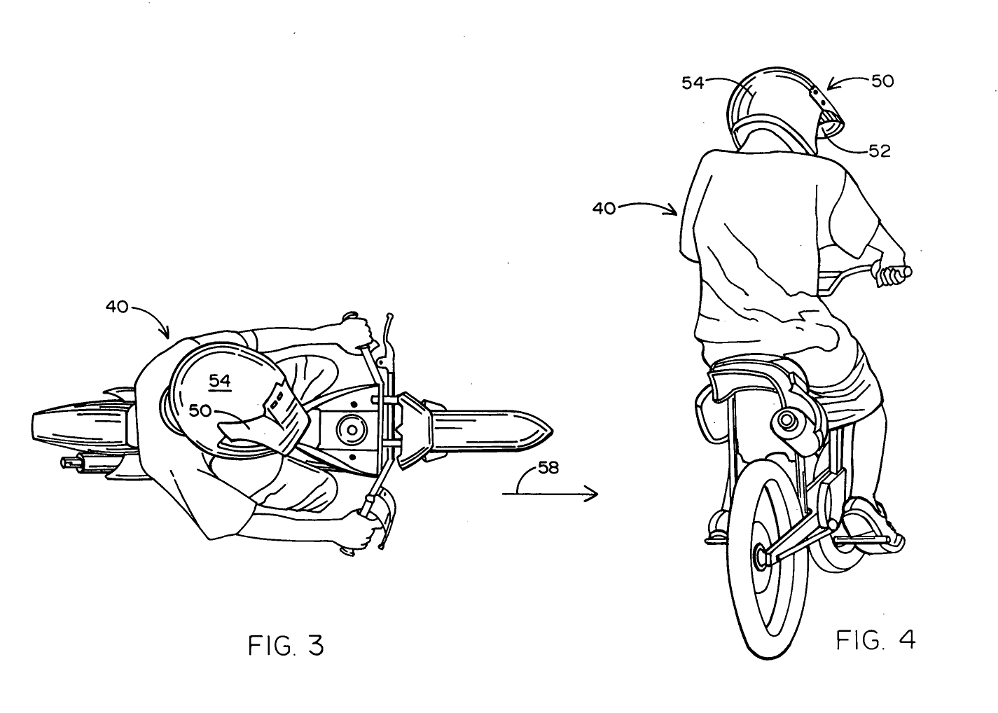

Similarly, FIGS. 3-4 illustrate how the first motorcycle rider 40 can see another motorcycle rider to his right and rear by turning his head slightly to the right and tilting his head slightly upward on his right to see an image of the other motorcycle rider in the mirror 52. It can be seen that the rider does not have to be twist his torso around at all.

It can also be seen in FIG. 2 that while viewing the image of the second motorcycle rider 42 in mirror 52, the first motorcycle rider 40 could easily shift his vision from the mirror to straight ahead, i.e. the direction of travel of the motorcycle, while maintaining his head slightly turned and slightly tilted as shown in FIGS. 1 and 2. Thus, it can be appreciated that without turning or repositioning his head from the position illustrated in FIGS. 1 and 2, but merely by eye movement alone the first rider 40 can quickly switch from viewing the path ahead of his motorcycle to viewing images in the mirror of objects to the rear and left side, and visa versa. The same viewing technique can be used for viewing objects on the motorcycle riders's rear and right side by turning and tilting his head slightly in the opposite directions as illustrated in FIGS. 3 and 4.

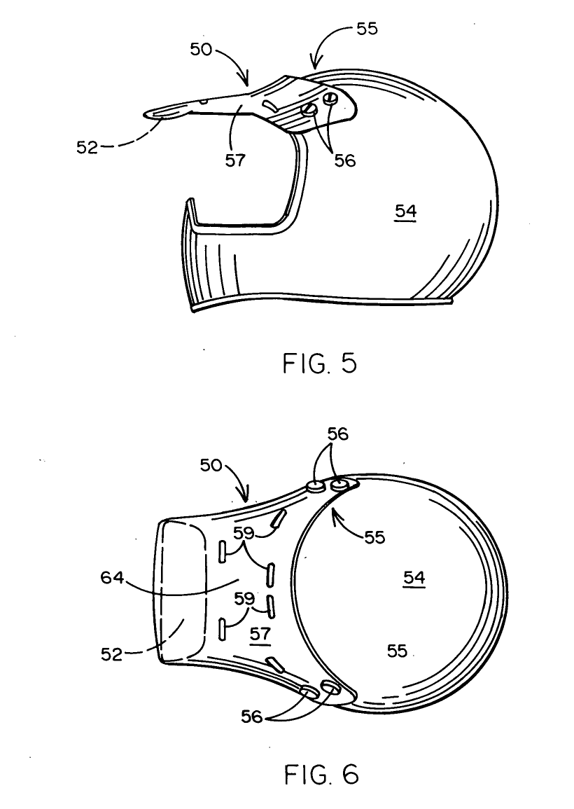

FIGS. 5-8 illustrate how a visor 50 with an integral mirror 52 of this invention is securely affixed to a forward portion 55 of an outer surface of helmet 54. For example, the visors with integral mirror of this invention can be securely affixed to the helmet with a plurality of fasteners 56 screwed into a plurality of corresponding internal threaded holes in the helmet in a conventional manner well known in the motorcycle helmet art thereby preventing movement or vibration of the mirror relative to the helmet.

The visor of this invention comprises a sun shade member 57 and an integral mirror 52 that is securely affixed to a forward portion 66 of an under surface of the sun shade member 57.

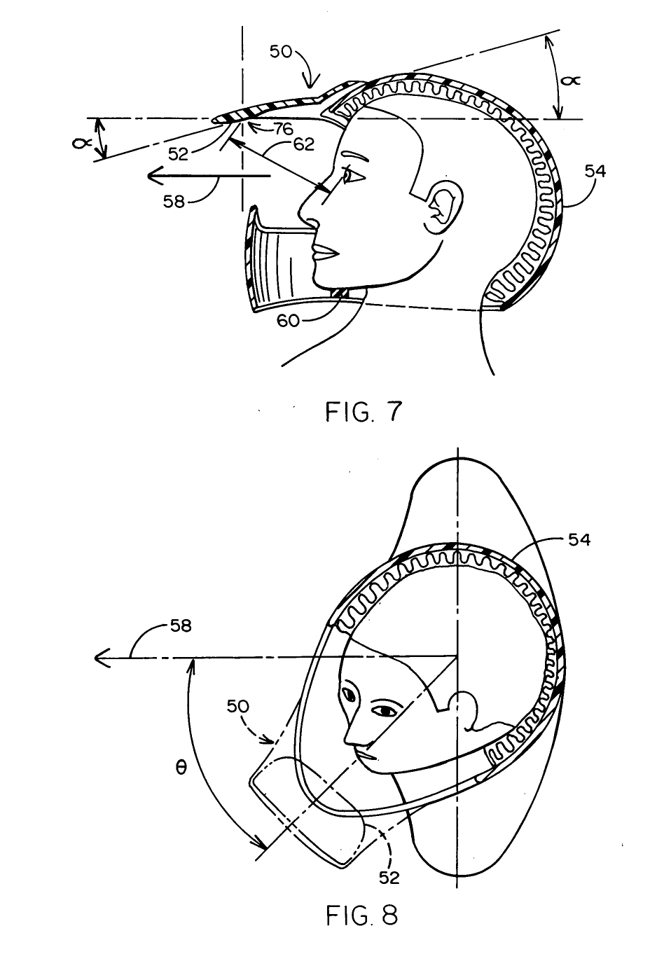

FIGS. 7 and 8, which are partly in cross section, and FIGS. 1 and 3, illustrate how the visor with integral mirror of this invention neither interferes with the line of sight 58 to the front of the direction of travel of the motorcycle nor obstructs the motorcycle rider's peripheral vision. Furthermore, even when the helmet wearer's head is turned slightly in the horizontal plane and tilted slightly from the vertical plane, as represented in by compound angle θ (theta), it can be appreciated that the visor with integral mirror of this invention will not interfere with the line of sight 58 to front and in the direction of travel of the motorcycle.

FIGS. 7 and 8 further illustrates that mirror 52 is to be positioned at a distance 62 that is effective for the user to see approximately the same field of view to the rear and a side of the direction of travel of the motorcycle with each of his eyes.

By positioning mirror 52 at or beyond such distance eye strain is lessened, and glancing from a line of sight 58 in the direction of travel of the motorcycle, and then to the mirror 52 is easier than if each eye were to see a substantially different field of view. These features, therefore, enable a motorcycle rider wearing a helmet with the visor with integral mirror of this invention to quickly and safely determine if another motorcyclist is close behind.

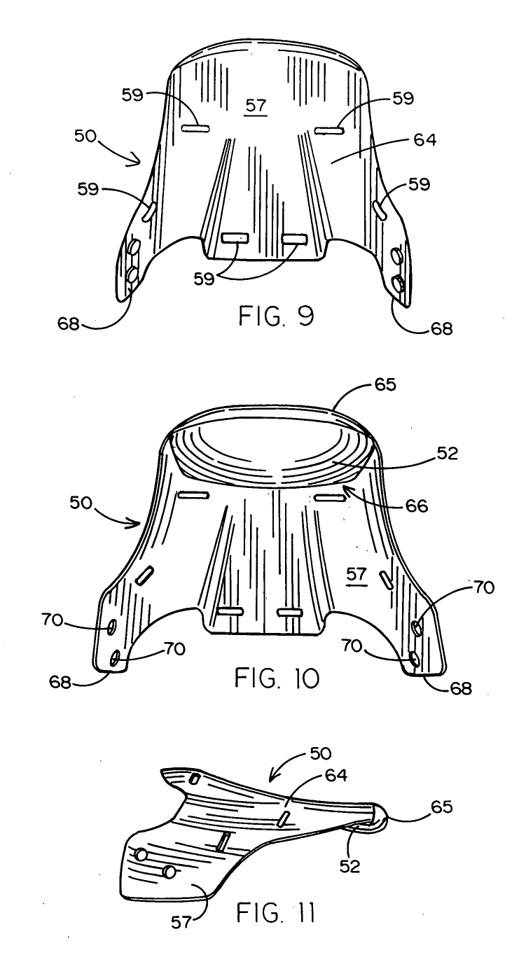

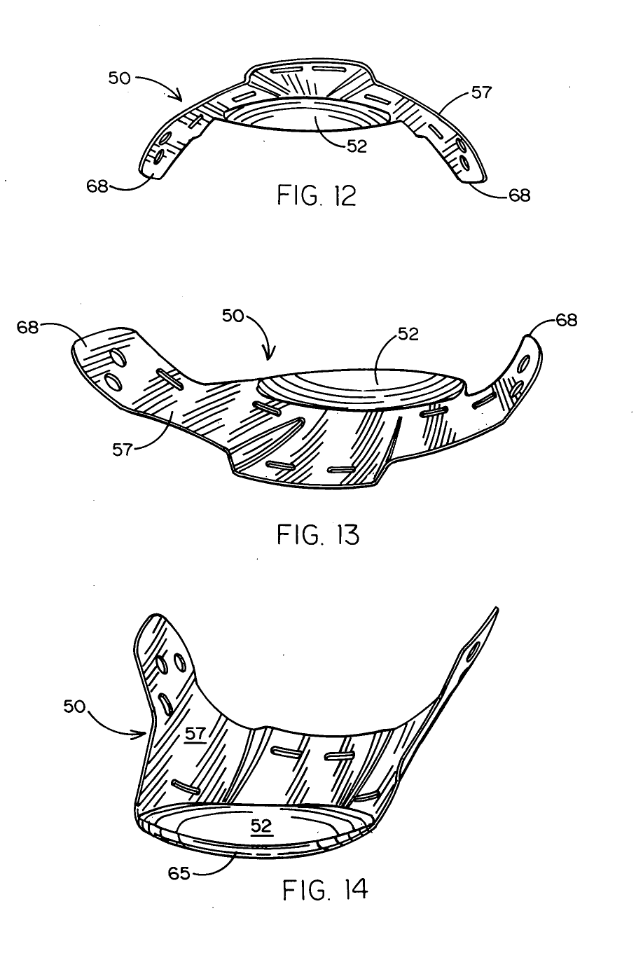

FIGS. 9-18 illustrate one embodiment of a visor 50 with integral mirror 52 of this invention. It is seen that top surface 64 and the leading edge 65 of the visor has a streamlined profile and that integral mirror 52 is securely affixed to a forward portion 66 of the bottom surface of sun shade member 57.

Left and right side flanges 68 of the visor are contoured to abut the forward portion 55 of the outer surface of helmet 54. Side flanges 68 have a plurality of apertures 70 for receiving a plurality of fasteners 56. Fasteners 56 can be threaded bolts with sufficient length to be received in a conventional manner in an associated plurality of internal threaded holes in the helmets that are sufficient size to securely affix the visor 50 to the helmet 54 and prevent movement of the visor relative to the helmet. The internal threaded holes in the helmet are not shown in the drawings since such means is well known in the motorcycle helmet art.

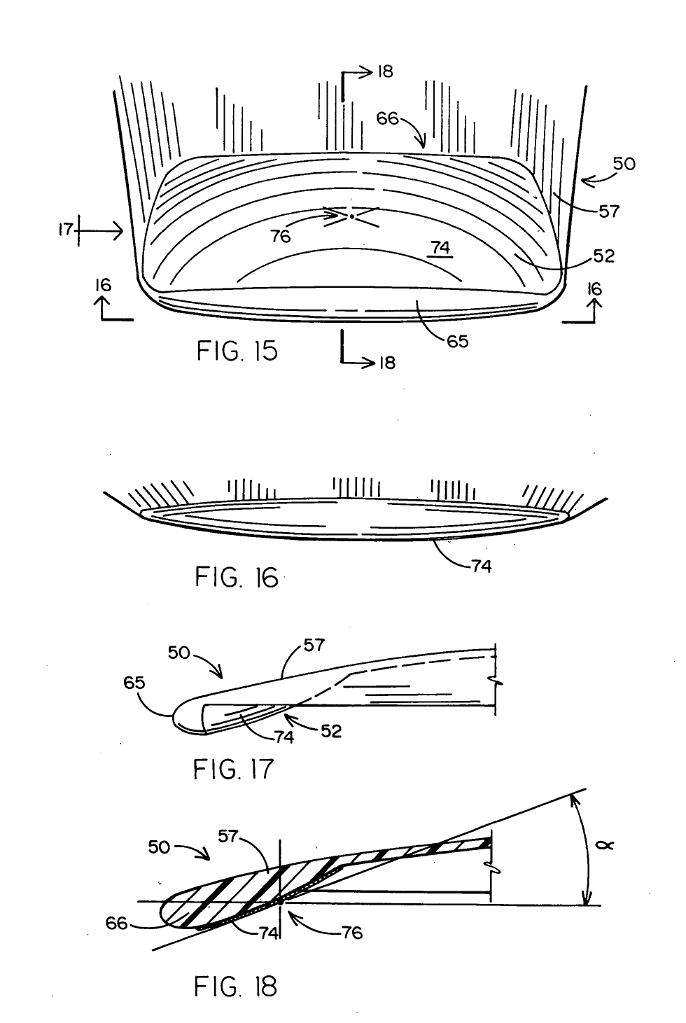

Enlarged details of the forward portion of visor 50 and integral mirror 52 are illustrated in FIGS. 15-18. Mirror 52 has a continuous convex reflective surface, and more preferably a continuous spherical reflective surface 74.

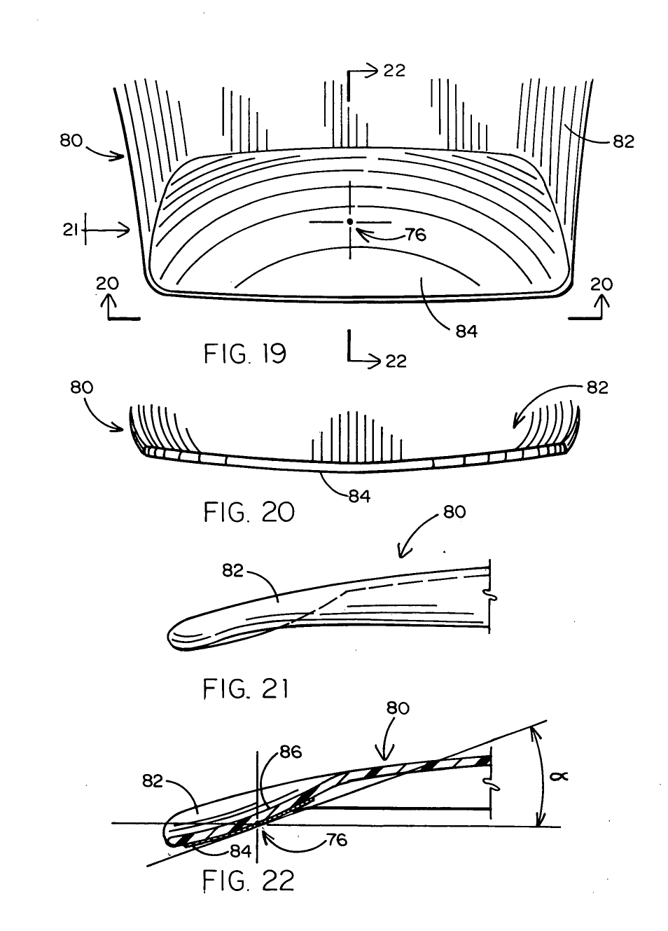

FIGS. 19-22 illustrate a detail of yet another embodiment of a visor 80 of this invention comprising a sun shade member 82 and an integral spherical mirror 84. In this embodiment, a forward portion 86 of the bottom surface of sun shade member 82 is contoured to abut and match a contour of the integral spherical mirror 84. This permits mirror 84 to be securely affixed to, or be formed on, or vapor deposited directly on, the bottom forward portion 86 of the sun shade member 82.

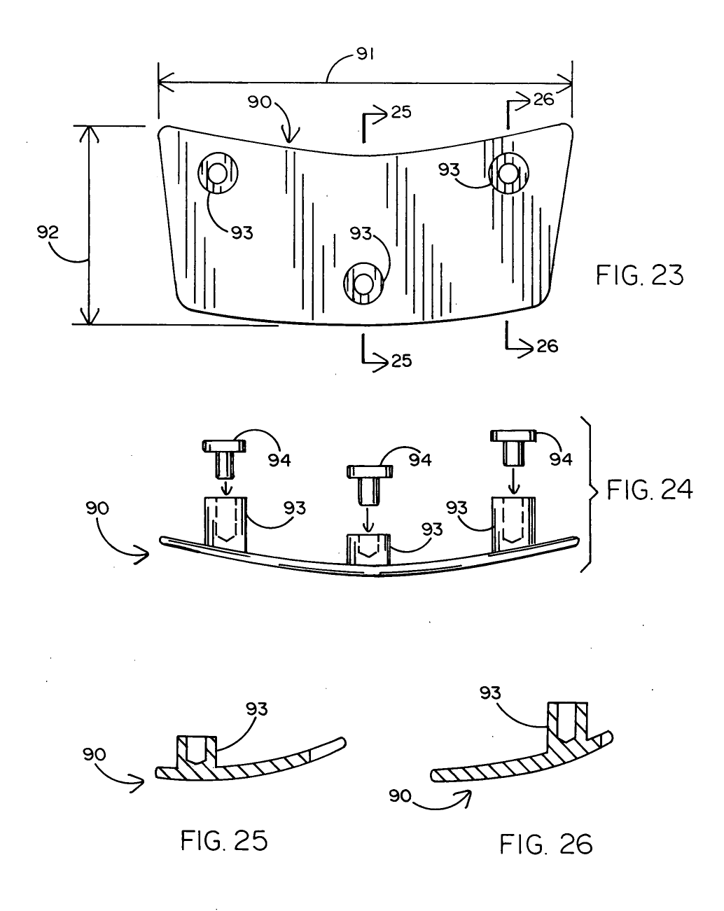

FIGS. 23-26 illustrate another embodiment of a mirror of this invention that can be retrofitted to sun shade members or other visors that do not have mirrors.

For example, a spherical mirror 90 can be affixed to an existing sun shade member that is affixed to an existing helmet. The spherical mirror has a lateral span 91 about two to three times larger than it's longitudinal span 92, a radius of curvature between about 7 inches and about 13 inches, an approximate trapezoidal projection in plane view and means for affixing the mirror to an under surface of the sun shade member. For example, the means for affixing the mirror can comprise a plurality of up-standing posts 93 that are internally threaded to receive externally threaded fasteners 94. Posts 93 are preferably made of a material that can be easily shortened, e.g. by filing, so that the mirror can be retrofitted to an existing sun shade member. The existing sun shade member can then be drilled to provide a corresponding plurality of apertures through which the fasteners 94 can be inserted and tighten to affix to the mirror of an existing sun shade member.

All of the mirrors of this invention have an average off-horizontal inclination at center-point 76 thereof of about 8° to about 35° as generally illustrated by angle α (alpha) in FIGS. 7. 15 and 19. In a another embodiment the average off-horizontal inclination at the center-point thereof, i.e. angle α, is about 10° to about 25°. In yet another embodiment the average off-horizontal inclination at the center-point thereof of about 11° to about 22°, and in a most preferred embodiment the average off-horizontal inclination at the center-point thereof of about 12° to about 20°.

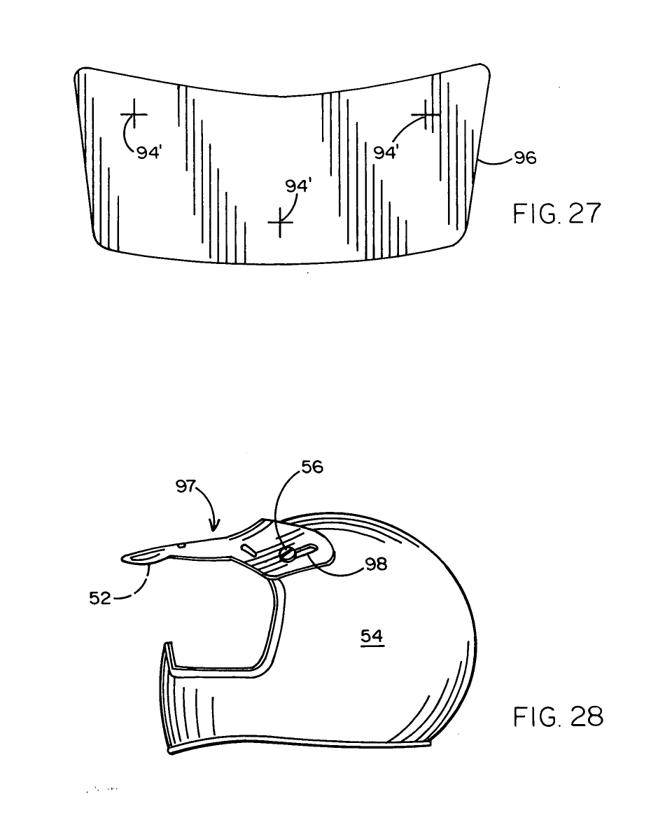

This invention also comprises a kit comprising the aforementioned mirror for affixing to an existing sun shade member and a template 96 for locating and marking the position on the sun shade member where a plurality of apertures are to be drilled. As illustrated in FIG. 27, template 96 with apertures 94′ can be aligned on the forward top surface of an existing sun shade member to indicate where apertures for fasteners 94 are to be drilled into the sun shade member. Mirror 90 can then be affixed to the sun shade member with fasteners 94.

One embodiment of this invention further comprises means for adjusting the distance between the mirror and the helmet. For example, as illustrated in FIG. 28, a visor 97 with integral mirror 52 has an elongated slot 98 that permits the visor to be positioned farther to the front of helmet 54 by loosening fasteners 56 on the side flanges 68 and sliding the visor further forward and retightening the fasteners. The mirror 52 can be similar to that illustrated in FIGS. 5-8.

The continuous reflective surfaces of this invention can be any mirror-like convex surface that will reflect visible light. Preferably, however, the reflective surface is a thin film of metal on a plastic surface. Metal vapor deposition processes that deposit the metal directly on plastic are preferable. Other reflective surfaces can be used such as polished aluminum on a polyester base, including a Mylar® brand plastic base, that is bonded to the forward bottom surface 86 of the sun shade member.

To reduce eye injury in case of a fall or other mishap with the motorcycle, the mirror is preferably free of glass. The visor is preferably made from a strong plastic including those plastics known in the motorcycle helmet art.

Although not shown in the figures, goggles, sunglasses or eyeglasses can be worn with the visors and mirrors of this invention.

What is claimed is:

1. A visor for a helmet, the visor comprising:
a sun shade member having means for removable attachment to the helmet, said means being effective for preventing movement of the visor relative to the helmet; and
a mirror affixed to an under surface of the sun shade member so that the mirror is not movable relative to the sun shade member,
the mirror having a continuous convex surface with a curvature that is free of discontinuations and step changes, the continuous convex surface having an average off-horizontal inclination at the center-point thereof of about 8° to about 35°, and
the mirror being spaced an effective distance from the user's eyes and having a lateral span and a longitudinal span that are large enough that the helmet wearer can simultaneously see approximately a same field of view with each eye to a side and rear in the mirror by a slight turn and tilt of the helmet wearer's head while an unobstructed line of sight in direction of travel is retained.

2. The visor of claim 1, wherein the continuous convex surface has an average off-horizontal inclination at the center-point thereof of about 10° to about 25°.

3. The visor of claim 1, wherein the continuous convex surface has an average off-horizontal inclination at the center-point thereof of about 11° to about 22°.

4. The visor of claim 1, wherein the continuous convex surface has an average off-horizontal inclination at the center-point thereof of about 12° to about 20°.

5. The visor of claim 1, wherein the visor is not lower than eye level of a wearer of the helmet,

6. The visor of claim 1, wherein the mirror does not extend beyond the combined external periphery of the sun shade member and the helmet.

7. The visor of claim 1, further comprising means for adjusting distance between the mirror and the helmet.

8. The visor of claim 1, wherein the visor is constructed entirely of plastic except for the mirror, and the mirror comprises a thin film of a polished metallic composition.

9. The visor of claim 1, wherein the visor is constructed entirely of plastic except for the mirror, and the mirror comprises a thin film of a polished aluminum.

10. The visor of claim 1, wherein the visor is constructed entirely of plastic except for the mirror, and the mirror comprises a thin film of polished aluminum on a plastic substrate.

11. The visor of claim 1, wherein the visor is free of an arm that extends between the visor and the continuous convex surface.

12. The visor of claim 1, wherein the visor is free of glass.

13. The visor of claim 1, wherein the means for removable attachment of the visor to the helmet comprises a plurality of holes in the visor that align with an associated plurality of internally threaded holes in the helmet, and a plurality of associated threaded fasteners for insertion through the plurality of holes and for screwing into the plurality of internal threaded holes.

14. The visor of claim 1, wherein the mirror is affixed to the under surface of the visor by a process comprising vapor deposition.

15. The visor of claim 1, wherein the continuous convex surface of the mirror is a continuous spherical surface.

16. The visor of claim 15, wherein the continuous spherical surface has an average off-horizontal inclination at the center-point thereof of about 10° to about 25°.

17. The visor of claim 15, wherein the continuous spherical surface has an average off-horizontal inclination at the center-point thereof of about 11° to about 22°.

18. The visor of claim 15, wherein the continuous spherical surface has an average off-horizontal inclination at the center-point thereof of about 12° to about 20°.

19. The visor of claim 15, wherein the mirror does not extend beyond the combined external periphery of the sun shade member and the helmet.

20. The visor of claim 15, wherein the mirror has a radius of curvature between about 7 inches and about 13 inches.

21. The visor of claim 15, wherein the mirror has a radius of curvature between about 8 inches and about 11 inches.

22. The visor of claim 15, wherein the mirror has a radius of curvature of about 9 inches.

23. The visor of claim 15, wherein the visor is not lower than eye level of a wearer of the helmet.

24. A continuous single spherical mirror for affixing to a sun shade member, the sun shade member for affixing to a helmet, the spherical mirror having a lateral span about three times larger than it's longitudinal spans a radius of curvature between about 7 inches and about 13 inches, and a means for affixing the mirror to an under surface of the sun shade member so that the continuous single spherical mirror will have an average off-horizontal inclination at the center-point thereof of about 8° to about 35°.

25. The continuous single spherical mirror of claim 24, wherein the mirror has a trapezoidal horizontal projection when affixed to the under surface of the sun shade member.

26. A kit for a sun shade member comprising:
a continuous single spherical mirror for affixing to a sun shade member, the sun shade member for affixing to a helmet, the spherical mirror having a lateral span about three times larger than it's longitudinal span, a radius of curvature between about 7 inches and about 13 inches, and a means for affixing the mirror to an under surface of the sun shade member so that the continuous single spherical mirror will have an average off-horizontal inclination at the center-point thereof of about 8° to about 35°; and
a template for a template for locating and marking a positions on the sun shade member where a plurality of apertures are to be drilled.
